(19) United States
(12) Patent Application Publication
(10) Pub. No.: US 2019/0210476 A1
(43) Pub. Date: Jul. 11, 2019

(54) CONTROL APPARATUS

(71) Applicant: DENSO CORPORATION, Kariya-city (JP)

(72) Inventor: Tomomi HASE, Kariya-city (JP)

(73) Assignee: DENSO CORPORATION, Kariya-city (JP)

(21) Appl. No.: 16/242,644

(22) Filed: Jan. 8, 2019

(30) Foreign Application Priority Data
Jan. 9, 2018 (JP) 2018-001498

(51) Int. Cl. B60L 53/12; B60L 53/36; B60L 58/13

(52) U.S. Cl. CPC B60L 53/12; B60L 58/13; B60L 53/36

(57) ABSTRACT

A control apparatus is applied to a vehicle that drives using electric power stored in a storage battery. In the control apparatus, a charging unit charges a storage battery with electric power supplied from a power supply apparatus provided outside of the vehicle via a power receiving unit provided in the vehicle. The vehicle control unit controls an own vehicle to make the own vehicle automatically exit a power supply position of the power supply apparatus when charging is ended. A completion condition determining unit determines whether a predetermined charging completion condition is met. An exit condition determining unit determines whether an exit condition that differs from the charging completion condition is met. The charging unit ends charging when the charging completion condition is determined to be met or the exit condition is determined to be met.

### CROSS-REFERENCE TO RELATED APPLICATION

This application is based on and claims the benefit of priority from Japanese Patent Application No. 2018-001498, filed Jan. 9, 2018. The entire disclosure of the above application is incorporated herein by reference.

### BACKGROUND

### Technical Field

The present disclosure relates to an apparatus that controls charging of a storage battery in a vehicle.

### Related Art

A contactless power supply system has been proposed. In the contactless power supply system, electric power is supplied to a vehicle, such as an electric car, in a contactless manner through electromagnetic induction. A storage battery provided in the vehicle is therefore charged.

### SUMMARY

An exemplary embodiment provides a control apparatus for a vehicle that drives using electric power that is stored in a storage battery. The control apparatus charges the storage battery with electric power supplied from a power supply apparatus provided outside of the vehicle via a power receiving unit provided in the vehicle. The control apparatus controls an own vehicle to make the own vehicle automatically exit a power supply position of the power supply apparatus when charging of the storage battery is ended. The control apparatus ends charging of the storage battery when a predetermined charging completion condition is determined to be met or when an exit condition that differs from the charging completion condition is determined to be met.

### BRIEF DESCRIPTION OF THE DRAWINGS

In the accompanying drawings:

FIG. 1 is a schematic diagram of a configuration of a power supply space region;

FIG. 2 is a diagram of an arrangement of a power supplying unit and a power receiving unit;

FIG. 3 is a block diagram of a contactless power supply system;

FIG. 4 is a flowchart of a charging process;

FIG. 5 is a flowchart of an exit determination process;

FIG. 6 is a schematic diagram of a configuration of a power supply space region in another example;

FIG. 7 is a schematic diagram of a configuration of the power supply space region in another example; and

FIG. 8 is a schematic diagram of a configuration of the power supply system periphery in another example.

### DESCRIPTION OF THE EMBODIMENTS

The following embodiments of the present disclosure relate to a control apparatus that is applied to a vehicle and controls charging of a storage battery in the vehicle.

A contactless power supply system supplies electric power to a vehicle, such as an electric car, in a contactless manner through electromagnetic induction and charges a storage battery in the vehicle. In the contactless power supply system, when a charging start time is reached based on scheduling, a vehicle that is parked in a parking position is moved to a power supply apparatus (power supply position) by automatic driving, and charging of the storage battery is automatically performed. In addition, when a charging end time is reached based on scheduling, charging is ended. The vehicle is moved from the power supply apparatus (power supply position) to the parking position by automatic driving.

However, when charging and movement of the vehicle are performed based on scheduling described above, a state of charge (SOC) of the storage battery may reach a target state before the charging end time is reached. In this case, the vehicle continues to occupy the power supply apparatus until the charging end time is reached. In cases in which the power supply apparatus is a public facility that is used by many people, if the vehicle continues to occupy the power supply apparatus based on scheduling, poor efficiency becomes an issue.

In addition, for example, in cases in which the SOC of the storage battery reaching the target state is set as a condition for ending the charging, if an abnormality occurs in the power supply and the charging cannot be performed normally, the charging will remain uncompleted for an indefinite amount of time. The vehicle may therefore continue to occupy the power supply apparatus. Efficiency is poor in this case as well.

It is thus desired to provide a control apparatus that suitably controls charging of a storage battery to enable efficient use of a power supply apparatus.

An embodiment in which a control apparatus is applied to a contactless power supply system 100 will hereinafter be described with reference to the drawings. Sections among the embodiments below that are identical or equivalent to each other are given the same reference numbers in the drawings.

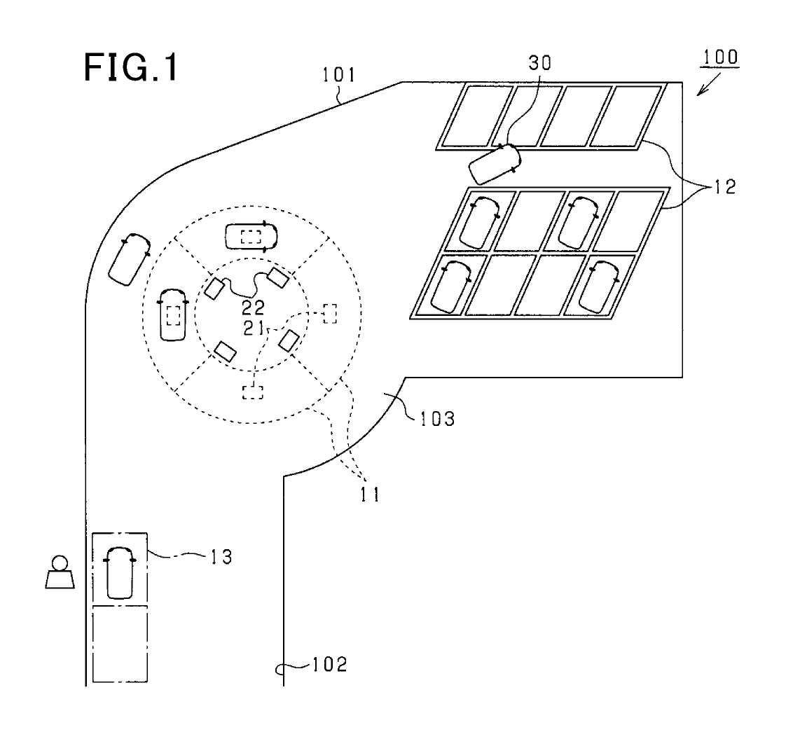

As shown in FIG. 1, the contactless power supply system 100 is provided on a predetermined sites (premises) 101. In addition, a power supply space 11, a parking space 12, and a waiting space 13 are provided on the sites 101. The power supply space 11 serves as a power supply position at which a vehicle 30 is supplied power. The parking space 12 serves as a parking position at which the vehicle 30 that has been supplied power is parked. The waiting space 13 serves as a waiting position at which the vehicle 30 that is awaiting power supply waits. A plurality of each of the spaces 11 to 13 are provided. Each of the spaces 11 to 13 has a width and a depth that, for example, allows parking of a single vehicle 30.

Furthermore, a vehicle entrance/exit 102 through which the vehicle 30 can enter and exit is provided on the sites 101. A road 103 that connects between the vehicle entrance/exit 102 and each of the spaces 11 to 13 is also provided on the sites 101. The spaces 11 to 13 and the road 103 are paved with asphalt or the like. The spaces 11 to 13 are divided by boundary lines or the like on the road surface. The aspect of the boundary line (such as color, line thickness, or line type) differs depending on the type of the spaces 11 to 13. The spaces 11 to 13 can be differentiated by the aspects of the boundary lines. For example, the line type refers to differences such as a solid line, a dashed line, a single-dot chain line, and a double line.

In FIG. 1 according to the present embodiment, the power supply spaces 11 are indicated by the dashed lines. The parking spaces 12 are indicated by the outlined white solid lines. The waiting spaces 13 are indicated by the single-dot chain lines. In addition, although the spaces 11 to 13 are divided by the boundary lines, the spaces 11 to 13 may also be divided by boundary portions such as curb stones.

As shown in FIG. 1, the plurality of power supply spaces 11 are arrayed on the sites 101 in a single row in the form of a circular ring. The plurality of parking spaces 12 are arranged in a position away from the power supply spaces 11 on the sites 101. The plurality of parking spaces 12 are arrayed in a plurality of rows in a linear manner. The plurality of waiting spaces 13 are provided near the power supply spaces 11 on the sites 101. The plurality of waiting spaces 13 are arrayed in a single row in a linear manner.

Next, the contactless power supply system 100 will be described. First, a power supply apparatus 20 will be described with reference to FIG. 1 to FIG. 3. The power supply apparatus 20 is a facility on the power-supply side (power-transmission side) in the contactless power supply system 100.

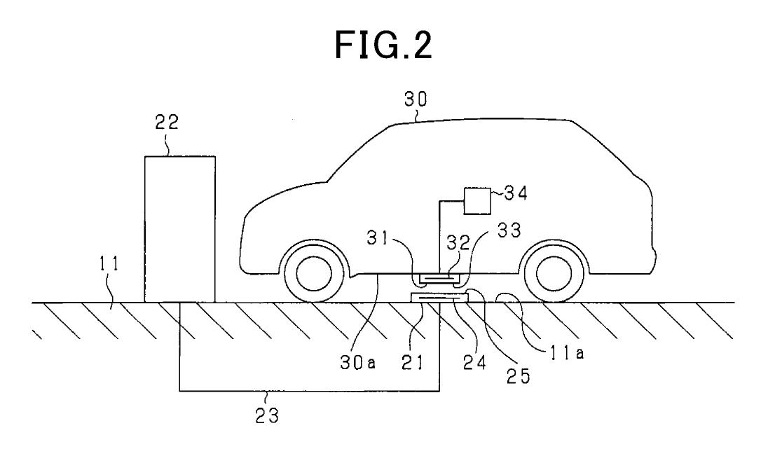

The power supply apparatus 20 provides a function for supplying (transmitting) electric power to the vehicle 30 in a contactlessing state. Each power supply space 11 is provided with the power supply apparatus 20. As shown in FIG. 2, the power supply apparatus 20 includes a power supplying unit (power transmission unit) 21 and a power source apparatus (power supply unit) 22. The power supplying unit 21 is provided within the power supply space 11. The power source apparatus 22 is provided adjacent to the power supply space 11. The power supplying unit 21 is connected to the power source apparatus 22 by a cable 23.

The power source apparatus 22 converts commercial power supplied from an electric power supply unit (not shown) to high-frequency power. The power source apparatus 22 then supplies the converted high-frequency power to the power supplying unit 21 via the cable 23. The power source apparatus 22 is erected on the road 103 in a position that does not obstruct passage of the vehicle 30. The setup location of the power source apparatus 22 may be arbitrarily changed. For example, the power source apparatus 22 may be buried underground. In addition, a plurality of power source apparatuses 22 may be gathered in a single location.

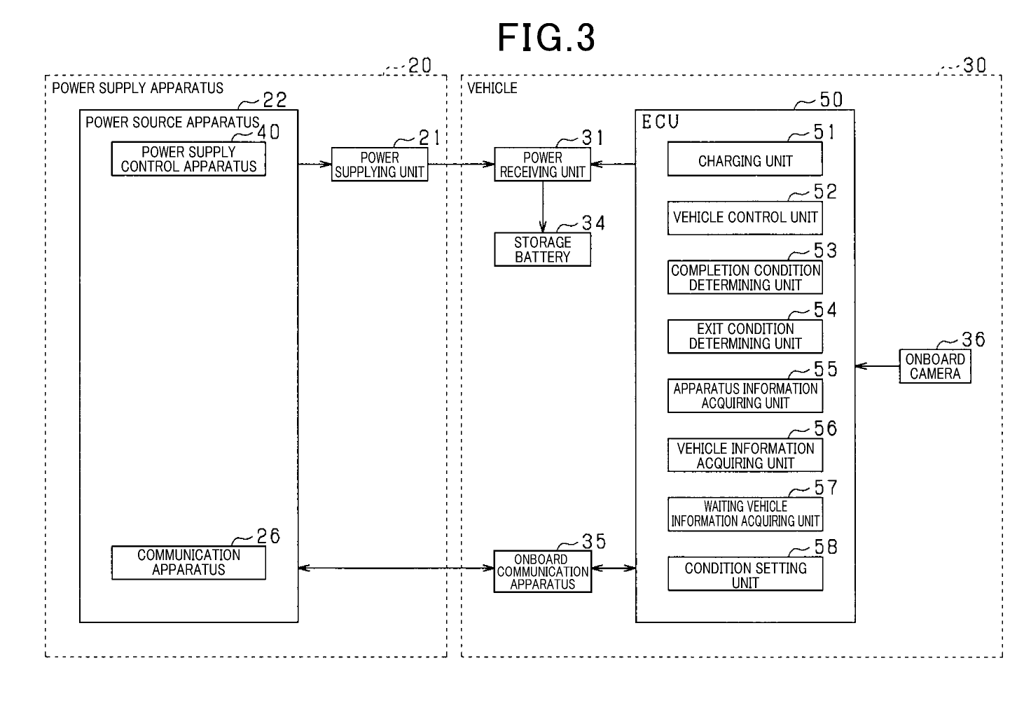

Furthermore, as shown in FIG. 3, the power source apparatus 22 includes a power supply control apparatus 40 that performs various processes, such as processes related to power supply control. The power supply control apparatus 40 is mainly configured by a microcomputer that is composed of a known central processing unit (CPU), read-only memory (ROM), random access memory (RAM), and the like. In addition, the power source apparatus 22 includes a communication apparatus 26 that is capable of communicating with the vehicle 30.

As shown in FIG. 2, the power supplying unit 21 is provided on a road surface 11a in each power supply space 11. The power supplying unit 21 is arranged so as to be positioned below (specifically, directly below) a power receiving unit 31 that is provided in the vehicle 30, when the vehicle 30 is parked in the power supply space 11. The power supplying unit 21 includes a power transmission coil 24 and a housing portion 25 that houses the power transmission coil 24. For example, the power transmission coil 24 is formed by a winding (such as litz wire) being wound in a planar shape.

The housing portion 25 is formed into a flat, rectangular box shape. The housing portion 25 has a square shape from a planar view. The housing portion 25 is composed of a non-magnetic material, such as a resin material or aluminum. The power transmission coil 24 is arranged inside the housing portion 25 such that an axial direction of the power transmission coil 24 faces a direction that is orthogonal to an upper surface and a lower surface of the housing portion 25.

A facility on the vehicle 30 side (power-reception side) in the contactless power supply system 100 will be described. According to the present embodiment, as the vehicle 30 that is parked and supplied power on the sites 101, a secondary battery-type battery-powered vehicle, such as an electric car or a plug-in hybrid vehicle (PHV), is assumed.

As shown in FIG. 2, the vehicle 30 has a power receiving unit 31 that serves as the facility on the vehicle 30 side of the contactless power supply system 100. The power receiving unit 31 is provided in a bottom portion 30a of the vehicle 30 (vehicle main body). The power receiving unit 31 includes a power reception coil 32 and a housing portion 33 that houses the power reception coil 32. The power reception coil 32 is formed by a winding (such as litz wire) being wound in a planar shape.

The housing portion 33 is formed into a flat, rectangular box shape. The housing portion 33 has a square shape from a planar view. The housing portion 33 is composed of a non-magnetic material, such as a resin material or aluminum. The housing portion 33 has a lower surface that is formed of a planar surface. The housing portion 33 is attached to the bottom portion (bottom surface) 30a of the vehicle 30 such that the lower surface of the housing portion 33 is parallel to the bottom portion 30a. In addition, in the attached state, the lower surface of the housing portion 33 is positioned below the bottom surface 30a of the vehicle 30a. The power reception coil 32 is arranged inside the housing portion 33 such that an axial direction of the power reception coil 32 faces a direction that is orthogonal to the lower surface of the housing portion 33.

In addition, as shown in FIG. 3, the vehicle 30 includes a storage battery 34 and an electronic control unit (ECU) 50 that serves as a control apparatus. The ECU 50 is mainly configured by a microcomputer that is composed of a known CPU, ROM, RAM, and the like.

The ECU 50 provides various functions, such as functions as a charging unit 51 and a vehicle control unit 52. The charging unit 51 controls charging of the storage battery 34. The vehicle control unit 52 controls movement of the vehicle 30. The various functions are implemented by the ECU 50 running programs stored in a storage apparatus (storage memory) provided in the ECU 50. The various functions may be implemented by an electronic circuit, i.e., as hardware. Alternatively, at least a portion of the various functions may be implemented by software, that is, a process performed on a computer.

The vehicle 30 driving (or traveling assistance for the vehicle 30) is performed as a result of an electric motor (not shown) being driven by the electric power stored in the storage battery 34. The vehicle 30 also includes an onboard communication apparatus 35 that is capable of communicating with the power source apparatus 22.

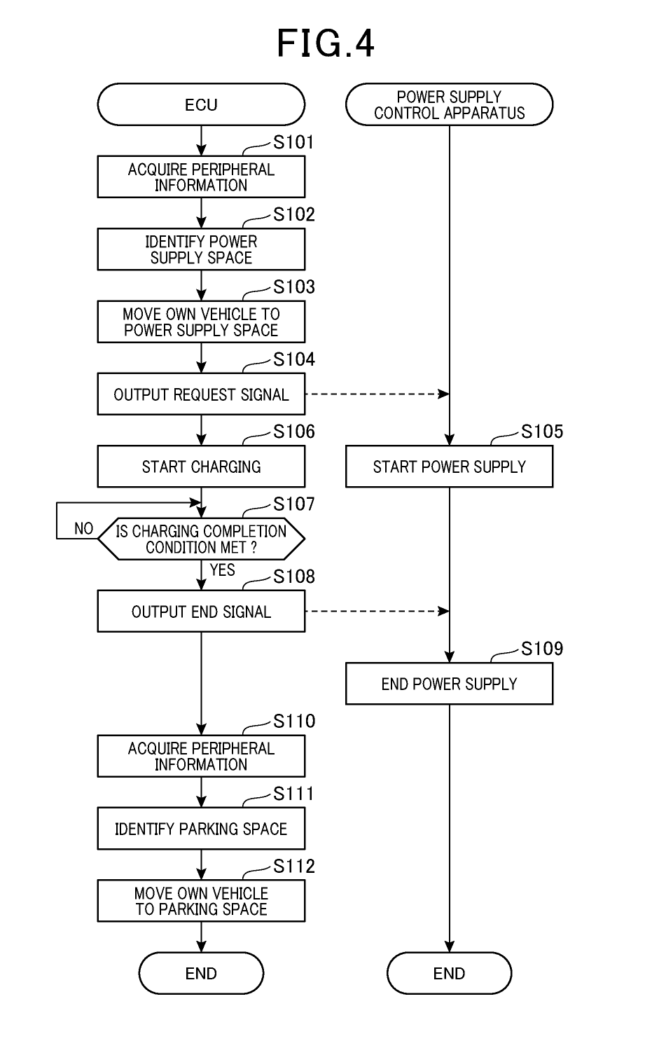

Next, a flow of processes that are performed when the storage battery 34 is charged will be described with reference to FIG. 4. When the vehicle 30 (own vehicle) is parked in the waiting space 13, the ECU 50 serving as the vehicle control unit 52 acquires peripheral information (such as a captured image of the own vehicle periphery) from an onboard camera 36 or the like (step S101).

The ECU 50 serving as the vehicle control unit 52 recognizes the power supply spaces 11 and the vehicles 30 (other vehicles) based on the acquired peripheral information, and identifies a power supply space 11 in which no vehicle 30 is parked (step S102).

The peripheral information may be acquired through inter-vehicle communication, communication with the power supply apparatus 22, or the like. In addition, the content of the peripheral information is not limited to the captured images and the like, and is merely required to be information that enables identification of the power supply space 11 in which no vehicle 30 is parked. For example, the peripheral information may be positional information on the power supply space 11 in which no vehicle 30 is parked.

When the power supply space 11 in which no vehicle 30 is parked is identified, the ECU 50 serving as the vehicle control unit 52 moves the own vehicle to the power supply space 11 and controls the own vehicle so as to be parked in the power supply space 11 (step S103).

Specifically, the ECU 50 recognizes obstacles including people, vehicles 30 (other vehicles), and the like from the acquired peripheral information, and determines a route to the power supply space 11 upon taking into consideration the positions of the obstacles. Then, the ECU 50 moves the own vehicle by controlling an accelerator, brakes, a steering wheel, and the like of the own vehicle based on the determined route. When parking the own vehicle in the power supply space 11, the ECU 50 controls the own vehicle so as to be in a state in which the power receiving unit 31 and the power supplying unit 21 oppose each other in a vertical direction.

When there is no power supply space 11 in which no vehicle 30 is parked, the ECU 50 may perform step S101 again after waiting for a predetermined amount of time.

Then, after parking the own vehicle in the power supply space 11, the ECU 50 serving as the charging unit 51 outputs a request signal for the start of power supply to the power supply control apparatus 40, via the onboard communication apparatus 35 (step S104).

When the request signal is received via the communication apparatus 26 on the power supply apparatus 20 side, the power supply control apparatus 40 controls the power source apparatus 22 so as to start the supply of high-frequency power to the power supplying unit 21 (power transmission coil 24) (step S105). When the high-frequency power is supplied to the power supplying unit 21 (power transmission coil 24) from the power source apparatus 22 in the state in which the power receiving unit 31 and the power supplying unit 21 are opposing each other in the vertical direction, a current flows to the power transmission coil 24 and magnetic flux is generated in the power transmission coil 24.

Then, as a result of the magnetic flux being changed, electromotive force (voltage) is generated in the power reception coil 32 of the power receiving unit 31 as a result of the effect of electromagnetic induction. As a result, power supply (power transmission) is performed from the power transmission coil 24 to the power reception coil 32 in a contactless manner.

The ECU 50 supplies the electric power supplied to the power reception coil 32 to the storage battery 34 from the power reception coil 32 and starts charging the storage battery 34 (step S106).

After the start of charging, the ECU 50 determines whether a charging completion condition is met at every predetermined cycle (step S107). When determined that the charging completion condition is not met (i.e., a NO determination is made at step S107), the ECU 50 performs the process at step S107 again after the elapse of a predetermined amount of time. Meanwhile, when determined that the charging completion condition is met (i.e, a YES determination is made at step S107), the ECU 50 outputs an end signal via the onboard communication apparatus 35 (step S108). The end signal indicates that charging is completed. When the end signal is received via the communication apparatus 26 on the power supply apparatus 20 side, the power supply control apparatus 40 ends power supply (step S109).

The ECU 50 serving as the vehicle control unit 52 acquires the peripheral information in a manner similar to that described above (step S110). Then, in a manner similar to that described above, the ECU 50 recognizes the parking spaces 12 and the other vehicles based on the peripheral information, and identifies a parking space 12 (predetermined parking position) in which no vehicle 30 is parked (step S111).

In a manner similar to that described above, when the parking space 12 in which no vehicle 30 is parked is identified, the ECU 50 serving as the vehicle control unit 52 moves the own vehicle to the parking space 12 and controls the vehicle 30 so as to be parked in the parking space 12 (step S112). As a result of the foregoing, charging is automatically performed. After the charging is completed, the own vehicle is automatically (without driving by a person) moved to the parking space 12.

Here, unlike a power supply apparatus 20 that is set in a residence, the power supply apparatus 20 according to the present embodiment is assumed to be a public facility. That is, use by a plurality of unspecified vehicles is assumed. Therefore, if charging is continued for each vehicle 30 until the charging completion condition is met, a situation in which a single vehicle 30 continues to occupy the power supply space 11 of the power supply apparatus 20 may occur.

For example, there are cases in which an abnormality occurs in the storage battery 34 of the vehicle 30 and the storage battery 34 cannot be charged. In this case, the vehicle 30 continues to occupy the power supply space 11 for a predetermined amount of time and the other vehicles 30 are unable to use the power supply apparatus 20. That is, efficient use of the power supply apparatus 20 cannot be achieved.

Therefore, the configuration is such that an exit condition is set separately from the charging completion condition. When the exit condition is met, the vehicle 30 is made to exit the power supply space 11. This configuration will be described in detail hereafter.

The ECU 50 includes a completion condition determining unit 53 and an exit condition determining unit 54. The completion condition determining unit 53 determines whether the charging completion condition is met at step S107. The exit condition determining unit 54 determines whether an exit condition that differs from the charging completion condition is met.

According to the present embodiment, for example, the charging completion condition is determined to be met when SOC of the storage battery 34 is in a target state. Meanwhile, according to the present embodiment, a plurality of types (three types) of exit conditions are provided. The own vehicle exits the power supply space 11 when any of the exit conditions is met.

A first exit condition is determined to be met when a predetermined prescribed amount of time (such as 30 minutes) has elapsed from when the own vehicle is parked in the power supply space 11. Specifically, the ECU 50 measures the amount of time elapsed from when the own vehicle is parked in any of the power supply spaces 11. When the predetermined prescribed amount of time has elapsed, the ECU 50 determines that the first exit condition is met.

A second exit condition is determined to be met when an abnormality is determined to have occurred in the own vehicle. Specifically, the ECU 50 provides a function as a vehicle information acquiring unit 56 that acquires information related to an abnormality in the own vehicle. Specifically, the ECU 50 detects a temperature of the storage battery 34 from a temperature sensor of the storage battery 34 and determines whether the temperature of the storage battery 34 is within a predetermined range. When determined that the temperature of the storage battery 34 is outside of the predetermined range, the ECU 50 determines than an abnormality has occurred in the vehicle 30.

The second exit condition is not limited to the temperature of the storage battery 34. The ECU 50 may acquire a temperature of the bottom portion 30a of the vehicle 30, a temperature of the power receiving unit 31, or the like, and similarly determine whether an abnormality has occurred. In addition, the ECU 50 may determine that an abnormality has occurred in the vehicle 30 when the SOC of the storage battery 34 cannot be detected, when communication with the power supply apparatus 20 cannot be performed, when power supply does not stop despite the SOC exceeding a prescribed value, and the like.

Furthermore, the ECU 50 may determine that an abnormality has occurred in the vehicle 30 when power supply efficiency is poor (such as when the electromotive force is equal to or less than a threshold). Moreover, regarding a power supply apparatus 20 that requires compensation (payment) for power supply, the ECU 50 may determine that an abnormality has occurred in the vehicle 30 when the payment is not performed normally (such as when a signal that indicates the completion of payment is not received). Payment may be performed through communication (electronic means) or the like, or may be performed using cash.

When determined that an abnormality has occurred in the vehicle 30, the ECU 50 stores information indicating the abnormality in the own vehicle in the storage apparatus provided in the ECU 50, as information related to an abnormality in the own vehicle. When determined that an abnormality has not occurred in the vehicle 30, the ECU 50 does not store the information related to an abnormality in the own vehicle or stores information indicating that the own vehicle is in a normal state. When the information indicating an abnormality in the own vehicle is acquired from the storage apparatus when determining whether the second exit condition is met, the ECU 50 determines that an abnormality has occurred in the own vehicle and determines that the second exit condition is met.

A third exit condition is determined to be met when an abnormality is determined to have occurred in the power supply apparatus 20. Specifically, the ECU 50 functions as an apparatus information acquiring unit 55 that acquires information related to an abnormality in the power supply apparatus 20 from the power supply apparatus 20, via the onboard communication apparatus 35.

The power supply control apparatus 40 provides a function for detecting an abnormality in the power supply apparatus 20 when the predetermined high-frequency power cannot be sent to the power transmission coil 24, when a temperature of the power transmission coil 24 is equal to or greater than a predetermined value, and the like. When an abnormality in the power supply apparatus 20 is detected, the power supply control apparatus 40 outputs information related to the abnormality in the power supply apparatus 20 to the vehicle 30, via the communication apparatus 26.

When the information related to an abnormality in the power supply apparatus 20 is acquired (received) from the power supply apparatus 20 via the onboard communication apparatus 35, the ECU 50 determines that an abnormality has occurred in the power supply apparatus 20. In this case, the ECU 50 determines than an abnormality has occurred in the power supply apparatus 20 and, in accompaniment, determines that the third exit condition is met.

Here, the power supply apparatus 20 according to the present embodiment is assumed to be used by a plurality of unspecified vehicles. Therefore, depending on the state of the vehicles 30 (referred to, hereafter, as waiting vehicles) that are awaiting power supply, it is thought that the power supply apparatus 20 can be more efficiently used as a result of the exit condition being changed, compared to when the exit condition is not changed.

Therefore, the ECU 50 provides a function as a waiting vehicle information acquiring unit 57 and a condition setting unit 58. The waiting vehicle information acquiring unit 57 acquires information related to the waiting vehicles. The condition setting unit 58 sets the first exit condition, among the exit conditions, based on the information related to the waiting vehicles.

For example, the ECU 50 serving as the waiting vehicle information acquiring unit 57 acquires peripheral information (such as a captured image of the own vehicle periphery) from an onboard camera 36 or the like. The ECU 50 extracts the waiting spaces 13 and the other vehicles based on the acquired peripheral information, and recognizes the information related to the waiting vehicles. Then, the ECU 50 determines whether a waiting vehicle is present (whether a vehicle 30 is parked in the waiting spaces 13) based on the recognized information. When a waiting vehicle is present, the ECU 50 recognizes the number of waiting vehicles.

The peripheral information may be acquired through inter-vehicle communication, communication with the power source apparatus 22, or the like. In addition, the content of the peripheral information is not limited to the captured images and the like, and is merely required to be information that enables determination of whether a vehicle 30 is present in the waiting spaces 13. For example, the presence of a waiting vehicle and the number of waiting vehicles may be identified through inter-vehicle communication with the vehicle 30 that is parked in the waiting space 30 (the vehicle 30 that is awaiting power supply).

Then, when determined that a waiting vehicle is present based on the acquired information related to the waiting vehicles, the ECU 50 serving as the condition setting unit 58 may set (change) the exit condition such that the exit condition is more easily met compared to when a waiting vehicle is determined not to be present. Specifically, the ECU 50 shortens the prescribed amount of time and thereby sets the exit condition such that the first exit condition is more easily met.

In addition, when determined that a waiting vehicle is present, in cases in which many waiting vehicles are present based on the acquired information related to the waiting vehicles, the ECU 50 sets the exit condition such that the exit condition is more easily met, compared to when fewer waiting vehicles are present. Specifically, the ECU 50 shortens the prescribed amount of time and thereby sets the exit condition such that the first exit condition is more easily met.

When determined that the charging completion condition is met or when determined that the exit condition is met, the ECU 50 serving as the charging unit 51 ends the charging. In addition, when the charging is ended, the ECU 50 serving as the vehicle control unit 52 controls the own vehicle so as to exit the power supply space 11.

Here, when the own vehicle is made to exit the power supply space 11 based on the exit condition, taking into consideration the usage efficiency of the power supply apparatus 20, the charging of the own vehicle is not completed. Therefore, if no issues arise in terms of usage efficiency of the power supply apparatus 20 and fairness, and if charging is possible, the charging of the own vehicle is preferably resumed and completed. Therefore, according to the present embodiment, when the own vehicle is made to exit the power supply space 11 as a result of the exit condition being met, a movement destination of the own vehicle is determined in a following manner.

When the first exit condition is met based on the elapse of the prescribed amount of time and the own vehicle is made to exit the power supply space 11, the ECU 50 determines that the own vehicle is to be moved to the waiting space 13 and moves the own vehicle to the waiting space 13. When the own vehicle is moved to the waiting space 13, the ECU 50 controls the own vehicle so as to be moved to the power supply space 11 again after the elapse of a predetermined amount of time and start (resume) charging. That is, the ECU 50 performs the processes at step S101 and subsequent steps shown in FIG. 4. When a vacant waiting space 13 is not present when the first exit condition is met, the ECU 50 may move the own vehicle to the parking space 12.

Meanwhile, when the second exit condition is met based on an abnormality in the own vehicle and the own vehicle is made to exit the power supply space 11, it is thought that charging will not be possible at other power supply apparatuses 20 as well. Therefore, when the second exit condition is met, the ECU 50 determines that the own vehicle is to be moved to the parking space 12 and controls the own vehicle so as to be moved to the parking space 12. That is, when determined that an abnormality has occurred in the own vehicle, the ECU 50 moves the own vehicle to the parking space 12 and does not resume charging.

When the third exit condition is met based on an abnormality in the power supply apparatus 20 and the own vehicle is made to exit the current power supply space 11, it is thought that power supply will be possible at another power supply apparatus 20. Therefore, when the third exit condition is met, the ECU 50 determines that the own vehicle is to be moved to another power supply space 11.

Then, the ECU 50 serving as the vehicle control unit 52 controls the own vehicle so as to be moved to another power supply space 11 in which another vehicle 30 is not parked. Then, after moving the own vehicle to the other power supply space 11, the ECU 50 starts (resumes) charging in a manner similar to that described above. That is, the ECU 50 performs the processes at step S104 and subsequent steps shown in FIG. 4.

When the third exit condition is met, then when no vacant power supply space 11 is present and when a vacant waiting space 13 is present, the ECU 50 may temporarily move the own vehicle to the waiting space 13 and then move the own vehicle to the other power supply space 11 after the elapse of a predetermined amount of time. When the waiting spaces 13 are also not vacant, the ECU 50 may move the own vehicle to a parking space 12.

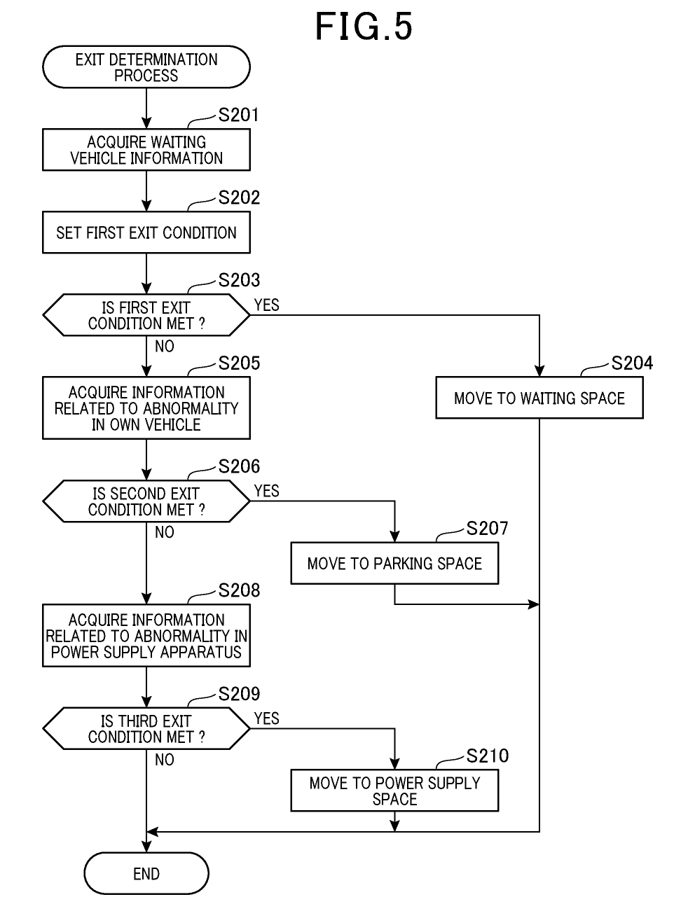

Next, the flow of processes until the own vehicle exits the power supply space 11 after the start of charging will be described with reference to FIG. 5. The ECU 50 performs an exit determination process shown in FIG. 5 at every predetermined cycle after the start of charging. More specifically, when determined that the charging completion condition is not met (when a NO determination is made at step S107), the ECU 50 performs the exit determination process before step S107 is performed again.

The ECU 50 acquires the information related to the waiting vehicles (step S201). Then, the ECU 50 sets the first exit condition based on the information related to the waiting vehicles (step S202). Specifically, the ECU 50 sets the prescribed amount of time based on the presence/absence of waiting vehicles and the number of waiting vehicles.

Then, the ECU 50 determines whether the first exit condition is met based on the amount of time from when the own vehicle is stopped in the power supply space 11 (step S203). Specifically, the ECU 50 determines whether the prescribed amount of time set at step S202 has elapsed from when the own vehicle is stopped in the power supply space 11.

When a YES determination is made at step S203 (i.e., the first exit condition is met), the ECU 50 identifies a vacant waiting space 13 and moves the own vehicle to the waiting space 13 (step S204). In addition, at step S204, the ECU 50 outputs the end signal and makes the power supply control apparatus 40 end power supply. Then, the ECU 50 ends the exit determination process. When the own vehicle is moved to the waiting space 13, the ECU 50 moves the own vehicle to the power supply space 11 after the elapse of a predetermined amount of time and resumes charging. That is, the ECU 50 performs the processes at step S101 and subsequent steps in FIG. 4. As described above, when a vacant waiting space 13 is not present, the ECU 50 may move the own vehicle to the parking space 12.

When a NO determination is made at step S203 (i.e., the first exit condition is not met), the ECU acquires the information related to an abnormality in the own vehicle from the storage apparatus (step S205). Then, the ECU 50 determines whether the second exit condition is met based on the information related to an abnormality in the own vehicle (step S206). Specifically, the ECU 50 determines that an abnormality has occurred in the own vehicle when the information indicating an abnormality in the own vehicle is stored, and determines that the second exit condition is met.

When a YES determination is made at step S206 (i.e., the second exit condition is met), the ECU 50 identifies a vacant parking space 12 and moves the own vehicle to the parking space 12 (step S207). In addition, at step S207, the ECU 50 outputs the end signal and makes the power supply control apparatus 40 end power supply. Then, the ECU 50 ends the exit determination process.

When a NO determination is made at step S206 (i.e., the second exit condition is not met), the ECU 50 acquires the information related to an abnormality in the power supply apparatus 20 (step S208). Then, the ECU 50 determines whether the third exit condition is met based on the information related to an abnormality in the power supply apparatus 20 (step S209). Specifically, the ECU 50 determines that an abnormality has occurred in the power supply apparatus 20 when the information indicating an abnormality in the power supply apparatus 20 is acquired, and determines that the third exit condition is met.

When a YES determination is made at step S209 (i.e., the third exit condition is met), the ECU 50 identifies another vacant power supply space 11 and moves the own vehicle to the other power supply space 11 (step S210). In addition, at step S210, the ECU 50 outputs the end signal and makes the power supply control apparatus 40 end power supply. Then, the ECU 50 ends the exit determination process. When the own vehicle is moved to the other power supply space 11, the ECU 50 resumes charging in the other power supply space 11. That is, the ECU 50 performs the processes at step S101 and subsequent steps in FIG. 4.

Meanwhile, when a NO determination is made at step S209 (i.e., the third exit condition is not met), that is, when determined that the exit condition is not met, the ECU 50 ends the exit determination process. When the exit condition is not met, the ECU 50 proceeds to the process at step S107 after the elapse of a predetermined amount of time and determines whether the charging completion condition is met. Subsequently, the ECU 50 repeatedly performs the process at step S107 and the exit determination process until either of the charging completion condition and the exit condition is met.

The following excellent effects can be achieved as a result of the above-described configuration.

When the charge completion condition or the exit condition that differs from the charge completion condition is met, the ECU 50 ends charging and controls the own vehicle so as to automatically exit the power supply space 11. Therefore, for example, when the power supply apparatus 20 is used by a plurality of vehicles 30, a situation in which the power supply apparatus 20 is continuously occupied by a single vehicle 30 because charging is not completed can be avoided. Consequently, charging of the storage battery 34 can be suitably controlled. The power supply apparatus 20 can be efficiently used by the plurality of vehicles 30.

To enable the power supply apparatus 20 to be efficiently and fairly used by the plurality of vehicles 30, exit is preferably facilitated and the amount of time over which each vehicle 30 occupies the power supply apparatus 20 (power supply space 11) is preferably shortened when a waiting vehicle is present, compared to when a waiting vehicle is not present. Therefore, the ECU 50 sets the first exit condition such that the first exit condition is more easily met when a waiting vehicle is present, compared to when a waiting vehicle is not present. Specifically, the prescribed amount of time of the first exit condition is shortened. Consequently, the power supply apparatus 20 can be efficiently and fairly used by the plurality of vehicles 30.

To enable the power supply apparatus 20 to be efficiently used by the plurality of vehicles 30, exit is preferably facilitated and the amount of time over which each vehicle 30 occupies the power supply apparatus 20 (power supply space 11) is preferably shortened when many waiting vehicles are present, compared to when few waiting vehicles are present. Therefore, the ECU 50 sets the first exit condition such that the first exit condition is more easily met when many waiting vehicles are present, compared to when few waiting vehicles are present. Specifically, the prescribed amount of time of the first exit condition is shortened. Consequently, the power supply apparatus 20 can be efficiently used by the plurality of vehicles 30.

Even when the own vehicle is made to exit the power supply space 11 without the completion of charging as a result of the exit condition being met, charging is preferably resumed if no issues arise in terms of usage efficiency of the power supply apparatus 20 and fairness as a result of charging being resumed. Therefore, when the own vehicle is made to exit the power supply space 11 as a result of the first exit condition being met, the ECU 50 moves the own vehicle to a vacant waiting space 13. Then, the ECU 50 automatically moves the own vehicle to the power supply space 11 again after the elapse of a predetermined amount of time and resumes charging. Consequently, charging can be reliably completed while ensuring that the power supply apparatus 20 is efficiently and fairly used by the plurality of vehicles 30.

When determined that an abnormality has occurred in the own vehicle or the power supply apparatus 20, the ECU makes the own vehicle exit the current power supply space 11. As a result, the own vehicle can be prevented from continuously occupying the power supply space 11 when charging cannot be appropriately performed. At this time, when an abnormality has occurred in the own vehicle, charging is not possible at any power supply apparatus 20. Therefore, the ECU 50 controls the own vehicle so as to be moved to the parking space 12.

Meanwhile, when an abnormality has occurred in the current power supply apparatus 20, charging may be possible as a result of the own vehicle being moved to another power supply space 11. Therefore, when an abnormality has occurred in the current power supply apparatus 20, the ECU 50 moves the own vehicle to another power supply space 11 and resumes charging. Consequently, charging can be appropriately completed.

The power supply apparatus 20 performs power supply to the vehicle 30 in a contactless manner. That is, the power receiving unit 31 is supplied electric power from the power supply apparatus 20 in a contactless manner. When power supply is performed in a contactless manner, compared to when power supply is performed with contact (or connection), the likelihood of variations in the supplied power and the likelihood of defects of some sort increase. Therefore, as a result of the exit condition being prescribed separately from the charging completion condition, even if variations in the supplied power occur, the vehicle 30 continuously occupying the power supply apparatus 20 can be suppressed. The power supply apparatus 20 can be efficiently and fairly used.

### Other Embodiments

The present disclosure is not limited to the above-described embodiment. For example, the present disclosure may be carried out as described below. Hereafter, sections that are identical or equivalent to each other among the embodiments are given the same reference numbers. Descriptions of sections having the same reference numbers are applicable therebetween.

According to the above-described embodiment, when the exit condition is met, a passenger of the vehicle 30 may be notified of the exit from the power supply space 11.

According to the above-described embodiment, when a vacant parking space 12 is not present (or a vacant parking space 12 cannot be identified) when the vehicle 30 is to be moved to the parking space 12, the vehicle 30 may wait while remaining in the power supply space 11. In addition, the vehicle 30 may temporarily exit the power supply space 11 and continuously travel on the road 103 until a vacant parking space 12 is identified. This also similarly applies when the vehicle 30 is to be moved to the waiting space 13 or the power supply space 11.

According to the above-described embodiment, the vehicle 30 is moved to another power supply space 11 and charging is resumed when charging is possible upon the third exit condition being met. However, the present disclosure is not limited thereto. That is, the vehicle 30 may be directly moved to the parking space 12 and charging may not be resumed.

According to the above-described embodiment, the vehicle 30 is moved to a vacant waiting space 13 when the first exit condition is met. However, the present disclosure is not limited thereto. That is, the vehicle 30 may be directly moved to the parking space 12 and charging may not be resumed.

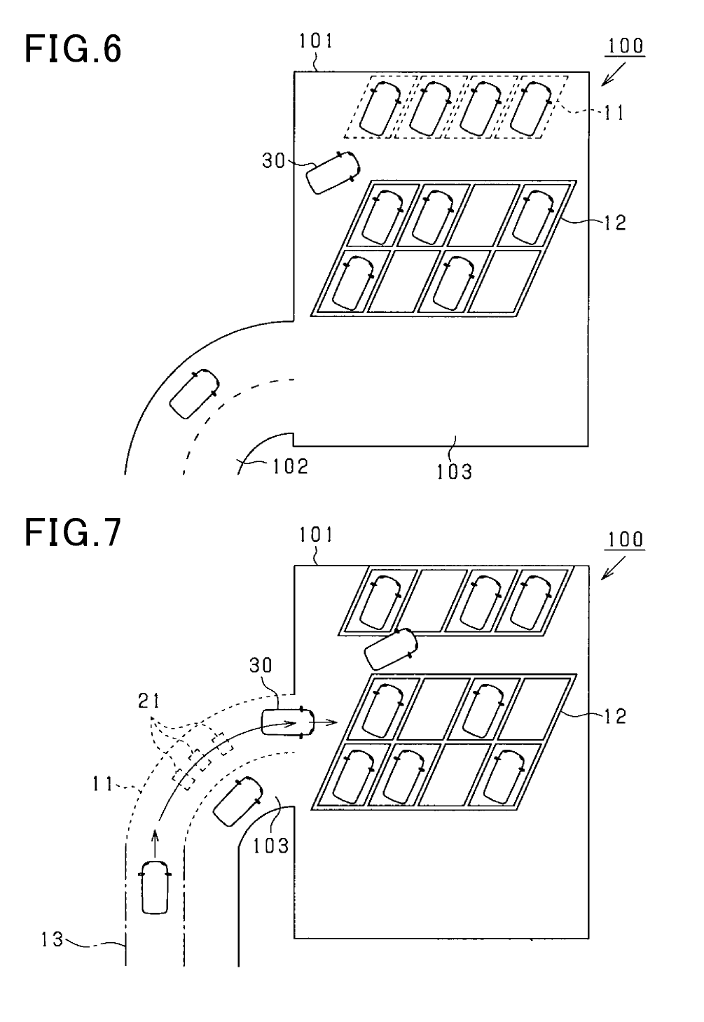

According to the above-described embodiment, the waiting space 13 is provided. However, as shown in FIG. 6, the waiting space 13 may not be provided. In this case, the vehicle 30 may be parked in the power supply space 11 as a result of driving by a person. In addition, the vehicle 30 that is awaiting power supply may be parked in the parking space 12 or may continuously travel on the road 103 as a result of being driven by a person or the ECU 50.

Then, when a power supply space 11 becomes vacant, the vehicle 30 may be moved to the power supply space 11. In these cases, the presence/absence of waiting vehicles and the number of waiting vehicles can no longer be identified through captured images. In this case, for example, the presence/absence of waiting vehicles and the number of waiting vehicles may be made identifiable through inter-vehicle communication or a specific signal (such as a lamp).

According to the above-described embodiment, the exit condition (first exit condition) is changed based on the presence/absence of the waiting vehicles and the number of waiting vehicles. However, the exit condition may be unchanged.

According to the above-described embodiment, the types of the spaces 11 to 13 are differentiated based on the aspects of the boundary portions, such as the boundary lines. However, the types of the spaces 11 to 13 may be differentiated using road markings, signs, and the like. In addition, in a similar manner, road markings, signs, or the like indicating vacant spaces 11 to 13 may be made identifiable based on captured images from a camera or the like.

According to the above-described embodiment, the vehicle 30 is parked in the power supply space 11 and supplied power. However, the vehicle 30 may be supplied power while moving. In this case, as shown in FIG. 7, a traveling route may be provided within the power supply space 11, and a plurality of power supplying units 21 may be arranged along the traveling route.

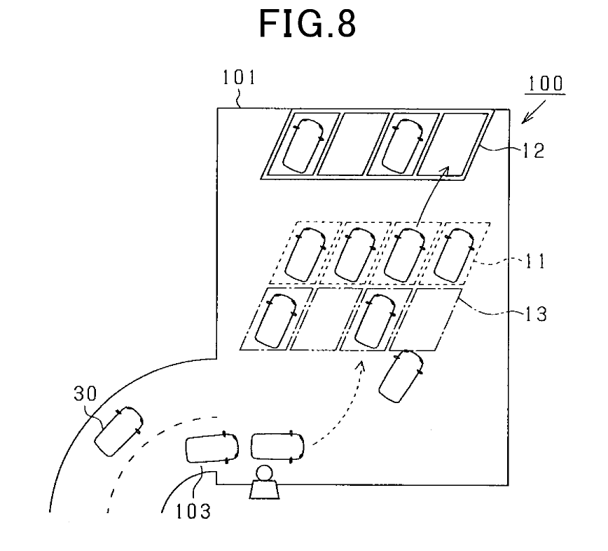

According to the above-described embodiment, the arrangement and layout of the spaces 11 to 13 may be arbitrarily changed. The quantities of the spaces 11 to 13 may also be arbitrarily changed. For example, the spaces 11 to 13 may be arranged as shown in FIG. 8.

According to the above-described embodiment, the vehicle 30 may be parked in the power supply space 11 by being driven by a person.

According to the above-described embodiment, the power supplying unit 21 is provided for each power source apparatus 22. However, a plurality of power supplying unit 21 may be provided for a single power source apparatus 22. The power supply control apparatus 40 of the single power source apparatus 22 may control the plurality of power supplying units 21 and simultaneously perform power supply for a plurality of vehicles 30.

According to the above-described embodiment, the number of exit conditions and the content thereof may be arbitrarily changed. For example, the exit condition may be determined to be met when a signal (command) requesting exit is received from the power supply apparatus 20 or another apparatus.

According to the above-described embodiment, charging is not resumed when the second exit condition is met based on an abnormality in the vehicle 30. However, charging may be resumed when the second exit condition is met based on an abnormality in the vehicle 30. For example, charging may be resumed when the temperature of the storage battery 34 falls within an appropriate range and the reason for the abnormality in the vehicle 30 is resolved after the vehicle 30 is made to exit the power supply space 11.

According to the above-described embodiment, the charging completion condition may be changed. For example, the charging completion condition may be met when the SOC of the storage battery 34 improves by a predetermined amount. In addition, for example, the charging completion condition may be met when a predetermined completion time has elapsed from when the own vehicle is parked in the power supply space 11. In this case, the first exit condition and the charging completion condition are required to differ.

For example, the first exit condition may be met when the SOC of the secondary battery 34 is equal to or greater than a predetermined charging threshold. When the first exit condition is met when the SOC of the secondary battery is equal to or greater than the predetermined charging threshold, the charging threshold may be changed based on the presence/absence of the waiting vehicles.

In this case, when the waiting vehicle is present, compared to when the waiting vehicle is not present, the charging threshold may be set to a lower value such that the first exit condition is more easily met. In a similar manner, the charging threshold may be changed based on the number of waiting vehicles. In this case, when many waiting vehicles are present, compared to when few waiting vehicles are present, the charging threshold may be set to a lower value such that the first exit condition is more easily met.

According to the above-described embodiment, power supply is performed in a contactless manner. However, the present disclosure is not limited to contactless power supply. For example, power supply may be performed through connection by a power source plug. In this case, a configuration in which the power source plug is automatically attached and detached is preferable. In addition, power supply may be performed after the power supplying unit 21 and the power receiving unit 31 are placed in contact.

According to the above-described embodiment, the first exit condition is changed based on the state of the waiting vehicles. However, the content of another exit condition may be changed. For example, in the case of the second exit condition, the exit condition may be more easily met by ranges and thresholds determined to be normal being changed. For example, the temperature range over which the storage battery 34 is determined to be abnormal may be changed. The threshold at which the power supply efficiency is determined to be abnormal may be changed.

According to the above-described embodiment, the power supply apparatus 20 may determine whether to allow power supply when the request signal is received. Then, when determined not to allow power supply, the power supply apparatus 20 may output a signal indicating that an abnormality has occurred in the power supply apparatus 20 or the vehicle 30.

According to the above-described embodiment, even when an abnormality (such as temperature abnormality) is not detected in the vehicle 30 or the power supply apparatus 20, in cases in which the power supply efficiency is poor (or power supply is not started), the ECU 50 may restart or repark the vehicle 30 in the power supply space 11 (or perform both). The ECU 50 may then perform the processes at step S104 and subsequent steps again. When the power supply efficiency is poor (or power supply is not started) upon the processes being performed again, the ECU 50 may determine that an abnormality has occurred in the vehicle 30.

The present disclosure may provide a control apparatus for a vehicle that drives using electric power that is stored in a storage battery. The control apparatus may include: a charging unit that charges the storage battery with electric power supplied from a power supply apparatus provided outside of the vehicle via a power receiving unit; a vehicle control unit that controls an own vehicle so as to make the own vehicle automatically exit a power supply position of the power supply apparatus when charging of the storage battery is ended; a completion condition determining unit that determines whether a predetermined charging completion condition is met; and an exit condition determining unit that determines whether an exit condition that differs from the charging completion condition is met. The charging unit ends charging of the storage battery when the completion condition determining unit determines that the charging completion condition is met or when the exit condition determining unit determines that the exit condition is met.

In the control apparatus, when the charging completion condition or the exit condition that differs from the charging completion condition is met, charging is ended and the own vehicle is made to automatically exit the power supply position. Therefore, for example, when the power supply apparatus is used by a plurality of vehicles, a situation in which the power supply apparatus continues to be occupied by a single vehicle because charging is not completed, and a situation in which the power supply apparatus is occupied for a fixed amount of time based on scheduling, regardless of a state of charge reaching a target state, can be avoided. Consequently, charging of the storage battery can be suitably controlled. The power supply apparatus can be efficiently used by a plurality of vehicles.

What is claimed is:

1. A control apparatus for a vehicle that drives using electric power that is stored in a storage battery, the control apparatus comprising:
a charging unit that charges the storage battery with electric power supplied from a power supply apparatus provided outside of the vehicle via a power receiving unit provided in the vehicle;
a vehicle control unit that controls an own vehicle to make the own vehicle automatically exit a power supply position of the power supply apparatus when charging of the storage battery is ended;
a completion condition determining unit that determines whether a predetermined charging completion condition is met; and
an exit condition determining unit that determines whether an exit condition that differs from the charging completion condition is met,
the charging unit ending charging of the storage battery when the completion condition determining unit determines that the charging completion condition is met or when the exit condition determining unit determines that the exit condition is met.

2. The control apparatus according to claim 1, comprising:
a waiting vehicle information acquiring unit that acquires information related to a waiting vehicle that is awaiting power supply; and
a condition setting unit that sets the exit condition, wherein
the condition setting unit sets the exit condition such that the exit condition is more easily met when the waiting vehicle is determined to be present based on the information acquired by the waiting vehicle information acquiring unit, compared to when the waiting vehicle is determined not to be present.

3. The control apparatus according to claim 2, wherein:
the condition setting unit sets the exit condition such that the exit condition is more easily met when more waiting vehicles are present based on the information acquired by the waiting vehicle information acquiring unit, compared to when fewer waiting vehicles are present.

4. The control apparatus according to claim 3, wherein:
the vehicle control unit automatically moves the own vehicle to the power supply position again after elapse of a predetermined amount of time from when the own vehicle is made to exit the power supply position as a result of the exit condition being met; and
the charging unit resumes charging after the own vehicle is moved to the power supply position again.

5. The control apparatus according to claim 4, further comprising:
an apparatus information acquiring unit that acquires information related to an abnormality in the power supply apparatus; and
a vehicle information acquiring unit that acquires information related to an abnormality in the own vehicle, wherein
the exit condition determining unit determines that the exit condition is met when an abnormality is determined to have occurred in the power supply apparatus based on the information acquired by the apparatus information acquiring unit or an abnormality is determined to have occurred in the own vehicle based on the information acquired by the vehicle information acquiring unit, and
the vehicle control unit moves the own vehicle to another power supply position and resumes charging when an abnormality is determined to have occurred in the power supply apparatus, and moves the own vehicle to a predetermined parking position and does not resume charging when an abnormality is determined to have occurred in the own vehicle.

6. The control apparatus according to claim 5, wherein:
the exit condition determining unit determines that the exit condition is met when a state-of-charge of the storage battery is in a target state.

7. The control apparatus according to claim 6, wherein:
the exit condition determining unit determines that the exit condition is met when a prescribed amount of time or more elapses after the own vehicle is parked in the power supply position.

8. The control apparatus according to claim 7, wherein:
the exit condition determining unit determines that the exit condition is met when an exit command is issued from the power supply apparatus.

9. The control apparatus according to claim 8, wherein:
the power receiving unit is supplied electric power from the power supply apparatus in a contactless manner.

10. The control apparatus according to claim 1, wherein:
the vehicle control unit automatically moves the own vehicle to the power supply position again after elapse of a predetermined amount of time when the own vehicle is made to exit the power supply position as a result of the exit condition being met; and
the charging unit resumes charging after the own vehicle is moved to the power supply position again.

11. The control apparatus according to claim 1, further comprising:
an apparatus information acquiring unit that acquires information related to an abnormality in the power supply apparatus; and
a vehicle information acquiring unit that acquires information related to an abnormality in the own vehicle, wherein
the exit condition determining unit determines that the exit condition is met when an abnormality is determined to have occurred in the power supply apparatus based on the information acquired by the apparatus information acquiring unit or an abnormality is determined to have occurred in the own vehicle based on the information acquired by the vehicle information acquiring unit, and
the vehicle control unit moves the own vehicle to another power supply position and resumes charging when an abnormality is determined to have occurred in the power supply apparatus, and moves the own vehicle to a predetermined parking position and does not resume charging when an abnormality is determined to have occurred in the own vehicle.

12. The control apparatus according to claim 1, wherein:
the exit condition determining unit determines that the exit condition is met when a state-of-charge of the storage battery is in a target state.

13. The control apparatus according to claim 1, wherein:
the exit condition determining unit determines that the exit condition is met when a prescribed amount of time or more elapses after the own vehicle is parked in the power supply position.

14. The control apparatus according to claim 1, wherein:
the exit condition determining unit determines that the exit condition is met when an exit command is issued from the power supply apparatus.

15. The control apparatus according to claim 1, wherein:
the power receiving unit is supplied electric power from the power supply apparatus in a contactless manner.

16. A control method for a vehicle that drives using electric power that is stored in a storage battery, the control method comprising:
charging the storage battery with electric power supplied from a power supply apparatus provided outside of the vehicle via a power receiving unit provided in the vehicle;
controlling an own vehicle to make the own vehicle automatically exit a power supply position of the power supply apparatus when charging of the storage battery is ended;
determining whether a predetermined charging completion condition is met;
determining whether an exit condition that differs from the charging completion condition is met; and
ending charging of the storage battery when the charging completion condition is determined to be met or when the exit condition is determined to be met.
